(19) United States
(12) Patent Application Publication
(10) Pub. No.: US 2026/0187782 A1
(43) Pub. Date: Jul. 2, 2026

(54) SYSTEMS AND METHODS FOR DETECTING RACE TRACK IMPERFECTIONS USING MACHINE LEARNING

(71) Applicants: Constructor Technology AG, Schaffhausen (CH); Constructor Education and Research Genossenschaft, Schaffhausen (CH)

(72) Inventors: Ilya SHIMCHIK, Zurich (CH); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 19/002,868

(22) Filed: Dec. 27, 2024

(51) Int. Cl. G06T 7/00; G06V 10/70; G06V 20/56

(52) U.S. Cl. CPC G06T 7/001; G06V 10/70; G06V 20/588; G06T 2207/30252

(57) ABSTRACT

A system receives sensor data for a race performed on a physical race track, wherein the sensor data captures a first plurality of parameters of a vehicle moving along a driving path. The system performs a racing simulation in which a virtual vehicle moves along a simulated driving path on a virtual race track, wherein the virtual race track corresponds to the physical race track and the simulated driving path corresponds to the driving path. The system generates virtual sensor data capturing a second plurality of physical parameters of the virtual vehicle moving along the simulated driving path. The system detects a difference between the first plurality of parameters and the second plurality of parameters at a first set of points in the driving path. The system executes a path imperfections machine learning (ML) model that receives the difference as an input and outputs track imperfections.

### FIELD OF TECHNOLOGY

The present disclosure relates to the field of machine learning, and, more specifically, to systems and methods for detecting race track imperfections using machine learning.

### BACKGROUND

In the realm of motorsports and automotive design, race track models serve as crucial tools for simulation, training, and strategic planning. However, these models often fall short of capturing the full complexity and imperfections of their real-world counterparts. Real race tracks are subject to a myriad of variables that can affect their condition and performance characteristics, such as weather conditions, surface wear, and even the natural settling of the ground over time. For instance, the Nürburgring in Germany, known for its challenging and varied terrain, presents a vastly different experience in reality compared to its digital or scaled-down models. Similarly, the Circuit de Monaco, with its tight corners and elevation changes, can be difficult to replicate accurately in a model due to the unique urban environment it traverses.

The importance of having accurate race track models cannot be overstated. Accurate models are essential for several reasons. Firstly, they provide drivers and teams with reliable data for training and strategy development, allowing them to anticipate and adapt to the nuances of the track. Secondly, they are vital for safety assessments, helping to detect and mitigate potential hazards that may not be apparent in less detailed models. Lastly, accurate models are crucial for the development of automotive technologies, such as autonomous vehicles, which rely on precise environmental data to function effectively. Inaccurate models can lead to miscalculations and errors, potentially compromising both performance and safety. Therefore, continuous efforts to enhance the fidelity of race track models are essential to bridge the gap between simulation and reality, ensuring that they serve as effective tools in the high-stakes world of racing.

### SUMMARY

To address the issues described previously, the present disclosure describes systems and methods that detect track imperfections. More specifically, the present disclosure describes gathering information about the imperfections in a track by comparing discrepancies in physical parameters captured during a simulated race and a real race. The imperfections are added onto a proprietary track model to achieve a more precise simulation.

In an exemplary aspect, the techniques described herein relate to a method for detecting race track imperfections using machine learning, the method including: receiving sensor data for a race performed on a physical race track, wherein the sensor data captures a first plurality of parameters of a vehicle moving along a driving path; performing a racing simulation in which a virtual vehicle moves along a simulated driving path on a virtual race track, wherein the virtual race track corresponds to the physical race track and the simulated driving path corresponds to the driving path; generating virtual sensor data capturing a second plurality of physical parameters of the virtual vehicle moving along the simulated driving path; detecting a difference between the first plurality of parameters and the second plurality of parameters at a first set of points in the driving path; and executing a path imperfections machine learning (ML) model that receives the difference as an input and outputs track imperfections at the first set of points that cause the difference.

In some aspects, the techniques described herein relate to a method, wherein the virtual race track is a model including a plurality of points each with track information, and the driving path includes a subset of the points where the vehicle has driven, and wherein the path imperfections ML model modifies track information for the first set of points in the subset of the points.

In some aspects, the techniques described herein relate to a method, wherein the track information is indicative of one or more of location, elevation, surface type, obstruction, and damage.

In some aspects, the techniques described herein relate to a method, further including: executing a generative ML model that receives, as an input, the track imperfections indicated in the subset of the points and the virtual race track, and outputs an updated virtual race track with possible imperfections across other points of the plurality of points that are not in the subset.

In some aspects, the techniques described herein relate to a method, further including storing the updated virtual race track in memory in place of the virtual race track.

In some aspects, the techniques described herein relate to a method, wherein the first plurality of parameters and the second plurality of parameters include one or more of: vertical acceleration, roll, pitch, yaw, point cloud data acquired by sensors such as LiDAR, radar, cameras, stereo-cameras etc., and suspension travel.

In some aspects, the techniques described herein relate to a method, wherein the first plurality of parameters and the second plurality of parameters further include one or more of: lateral acceleration, longitudinal acceleration, tire pressure, vehicle internal temperature, wheel speed data, global positioning system (GPS) data, track surface temperature, vibration data, humidity, ambient temperature, optical sensor data.

In some aspects, the techniques described herein relate to a method, wherein each type of difference from a plurality of difference types is mapped to an imperfection type from a plurality of imperfection types, and wherein the difference between the first plurality of parameters and the second plurality of parameters is mapped to the track imperfections.

It should be noted that the methods described above may be implemented in a system comprising at least one hardware processor and memory. Alternatively, the methods may be implemented using computer executable instructions of a non-transitory computer readable medium.

In some aspects, the techniques described herein relate to a system for detecting race track imperfections using machine learning, including: at least one memory; at least one hardware processor coupled with the at least one memory and configured, individually or in combination, to: receive sensor data for a race performed on a physical race track, wherein the sensor data captures a first plurality of parameters of a vehicle moving along a driving path; perform a racing simulation in which a virtual vehicle moves along a simulated driving path on a virtual race track, wherein the virtual race track corresponds to the physical race track and the simulated driving path corresponds to the driving path; generate virtual sensor data capturing a second plurality of physical parameters of the virtual vehicle moving along the simulated driving path; detect a difference between the first plurality of parameters and the second plurality of parameters at a first set of points in the driving path; and execute a path imperfections machine learning (ML) model that receives the difference as an input and outputs track imperfections at the first set of points that cause the difference.

In some aspects, the techniques described herein relate to a non-transitory computer readable medium storing thereon computer executable instructions for detecting race track imperfections using machine learning, including instructions for: receiving sensor data for a race performed on a physical race track, wherein the sensor data captures a first plurality of parameters of a vehicle moving along a driving path; performing a racing simulation in which a virtual vehicle moves along a simulated driving path on a virtual race track, wherein the virtual race track corresponds to the physical race track and the simulated driving path corresponds to the driving path; generating virtual sensor data capturing a second plurality of physical parameters of the virtual vehicle moving along the simulated driving path; detecting a difference between the first plurality of parameters and the second plurality of parameters at a first set of points in the driving path; and executing a path imperfections machine learning (ML) model that receives the difference as an input and outputs track imperfections at the first set of points that cause the difference.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a diagram illustrating an example of track conditions of a simulated track and track conditions of a real track.

FIG. 2 is a diagram illustrating driving paths that a vehicle may take when capturing data used to assess track imperfections.

FIG. 3 is a block diagram illustrating a system for detecting track imperfections based on sensor data.

FIG. 4 is a block diagram illustrating a system for training a path imperfections machine learning model to detect track imperfections based on sensor data.

FIG. 5 is a block diagram illustrating a method for detecting track imperfections based on sensor data.

FIG. 6 is a block diagram illustrating a method for training a path imperfections machine learning model to detect track imperfections based on sensor data.

FIG. 7 presents an example of a general-purpose computer system on which aspects of the present disclosure can be implemented.

### DETAILED DESCRIPTION

Exemplary aspects are described herein in the context of a system, method, and computer program product for detecting race track imperfections using machine learning. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

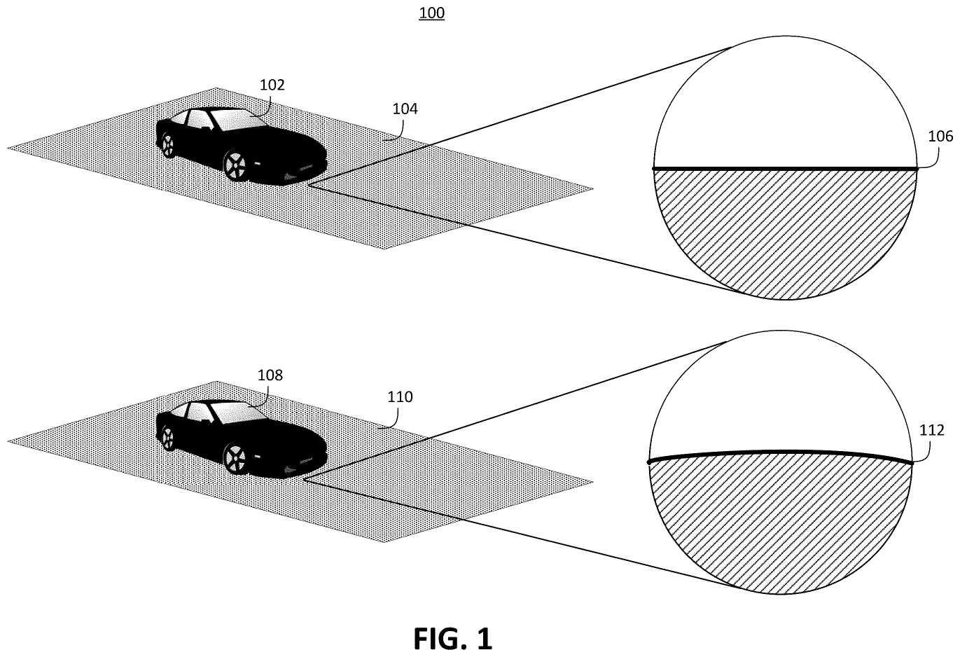

FIG. 1 is a diagram 100 illustrating an example of track conditions of a simulated track and track conditions of a real track. For example, simulated vehicle 102 may be driving on simulated track 104. Suppose that simulated track 104 is 10 feet (ft) wide and 30 feet long in diagram 100. It should be noted that the dimensions of simulated track 104 are kept small in diagram 100 for simplicity. One skilled in the art will appreciate that simulated track 104 may be longer and/or wider, and may have varying elevations, terrains, and curves.

Section 106 is an area underneath simulated vehicle 102. Suppose that section 106 is a 1 ft by 1 ft sample of simulated track 104 and is located at coordinates (X1, Y1, Z1) relative to a predetermined origin point of simulated track 104. The cross-section of section 106 indicates that the surface of section 106 is flat. For example, at X1, the Y-coordinates are increasing, but the Z coordinates are constant (no change in elevation).

When real vehicle 108 drives on real track 110, however, the data collected during the drive may indicate that the actual track has an imperfection that is not captured by simulated track 104. Suppose that simulated track 104 is generated to mimic real track 110 in all aspects (e.g., dimensions, terrain, slopes, curves, elevations, imperfections, etc.). Section 112 may be the same 1 ft by 1 ft area located at coordinates (X1, Y1, Z1), but represents the actual condition of the real-world track. As shown in diagram 100, section 112 has a slight bulge. On a technical level, this suggests that the Z coordinates along the Y-axis at X1 are not constant and there is a change in elevation. It should be noted that the bulge is simplified in diagram 100. In a real-world setting, the imperfection may be any three-dimensional bump, hole, curve, etc.

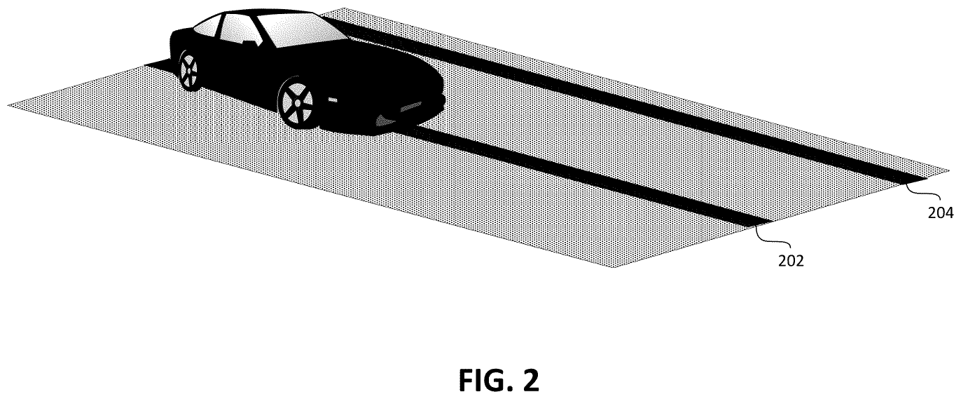

FIG. 2 is a diagram 200 illustrating driving paths that a vehicle may take when capturing data used to assess track imperfections. When a simulated or real vehicle moves across a track, sensors on the vehicle gather one or more physical parameters. These physical parameters may include, but are not limited to:
1. Vertical Acceleration: This measures the up-and-down forces acting on the vehicle. It can be used to assess the smoothness of the track surface, detect bumps or dips, and evaluate how these affect the vehicle's suspension and overall stability.
2. Roll: Roll refers to the tilting motion of the vehicle from side to side. By measuring roll, race teams can understand how the vehicle is responding to lateral forces during cornering, which can indicate the grip level of the track and the effectiveness of the vehicle's suspension setup.
3. Pitch: Pitch is the tilting motion of the vehicle forward or backward. This data helps in assessing how the vehicle reacts to acceleration and braking forces. It can also indicate changes in track elevation, such as inclines or declines, which affect the vehicle's balance and traction.
4. Yaw: Yaw measures the rotation of the vehicle around its vertical axis. It can be used to evaluate how the car is steering and maintaining its intended path. Yaw data can reveal issues with track grip, especially in corners, and help in detecting oversteer or understeer conditions.
5. LiDAR (Light Detection and Ranging): LiDAR uses laser pulses to create a detailed 3D map of the track surface. It can be used to assess surface quality, detect elevation changes, and identify any obstacles or debris on the track. LiDAR provides precise measurements of the track's topography, which is used to evaluate how the track conditions might affect vehicle performance.
6. Lateral Acceleration: This measures the side-to-side forces acting on the vehicle, which may indicate how the vehicle is handling turns and the grip level of the track surface.
7. Longitudinal Acceleration: This measures the forward and backward forces acting on the vehicle, providing insights into braking and acceleration performance, which may be affected by track conditions.
8. Tire Pressure and Temperature: Monitoring these may help assess how the track surface is affecting tire performance, which is used for understanding grip levels and surface quality.
9. Suspension Travel: This data may indicate how the vehicle's suspension is reacting to the track surface, revealing bumps, dips, and overall surface smoothness.
10. Wheel Speed Sensors: These may provide data on traction and may help detect wheel slip, which might indicate changes in surface conditions.
11. GPS Data: High-precision GPS may be used to map the track and detect elevation changes, camber, and banking of the track.
12. Surface Temperature: Infrared sensors may measure the temperature of the track surface, which affects tire grip and may vary across different sections of the track.
13. Vibration Sensors: These may detect the roughness of the track surface by measuring the vibrations experienced by the vehicle.
14. Humidity and Ambient Temperature: These environmental factors may affect track conditions, such as the likelihood of moisture on the track surface.
15. Optical Sensors: These may be used to detect surface texture and quality, identifying areas that might be worn or have different friction characteristics.

It should be noted that because the track's dimensions are likely larger than then dimensions of the vehicle, these physical parameters correspond to only a section of the track. For example, if the vehicle is moving along driving path 202, the collected data may or may not account for other sections of the track (e.g., the section marked along driving path 204). In order to get a complete picture of the entire track, the vehicle will also need to drive along path 204 and capture additional sensor data. However, simply having a vehicle drive over an infinite number of driving paths is inefficient. It should be noted that while driving paths 202 and 204 are straight lines, driving paths may take any shape that the vehicle is capable of moving in. Furthermore, certain driving paths may at least partially overlap.

Accordingly, the present disclosure introduces a path imperfections machine learning (ML) model and a generative ML model that are employed to extrapolate, from the collected sensor data of a real vehicle on a real track, and detect imperfections not captured by a simulated track. In this case, an imperfection is a physical difference between a simulated track and its real-world counterpart. For example, sections 106 and 112 are different in elevation, and this difference is considered an imperfection.

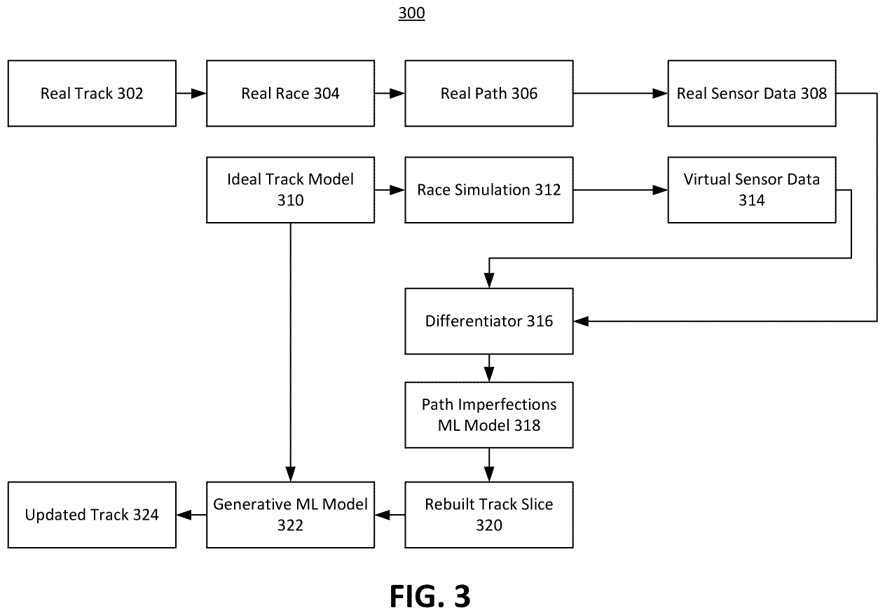

FIG. 3 is a block diagram illustrating system 300 for detecting track imperfections based on sensor data. In system 300, a real race 304 is conducted on real track 302. During real race 304, the vehicle (e.g., vehicle 108) travels along real path 306 and sensors connected to the vehicle collect real sensor data 308.

System 300 then executes a race simulation 312 in which a virtual vehicle (e.g., vehicle 102) drives along a virtual path identical to real path 306 on ideal track model 310. For example, GPS coordinates of the real vehicle may be tracked and translated into coordinates in race simulation 312. In some aspects, the real vehicle and the simulated vehicle are identical. In some aspects, ideal track model 310 is a standard proprietary ideal track model that recreates the physical attributes of real track 302. For example, ideal track model 310 may be a racing game version of a race track in the real-world.

As the simulated vehicle travels in ideal track model 310, simulated sensors generate virtual sensor data 314. Virtual sensor data 314 and real sensor data 308 each capture one or more of the physical parameters previously described. Differentiator 316 is configured to calculate discrepancies in these physical parameters between the simulated and real race throughout the entire course. For example, differentiator 316 may determine that at time t1, both the real vehicle and the simulated vehicle are located at a same point p1. However, at time t1 and point p1, the vertical acceleration of the real vehicle may be 1 m/s less than the vertical acceleration of the simulated vehicle. It is possible that this deviation may be due to an imperfection on the real track 302. For example, a vertical acceleration difference of 1 m/s may be caused by an elevation wave that is 3 centimeters (cm) by 5 meters (m) long. If the same path is driven on and the same vertical acceleration difference is detected at the same point(s), there is a greater likelihood that the real track 302 in fact has an imperfection.

Path imperfections ML model 318 is trained to correlate these discrepancies with specific points on the track to create a function of parameter deviation depending on the track location. Path imperfections ML model 318 may further create surface imperfections along the path by analyzing discrepancies in parameters between the simulated and real race. For example, path imperfections ML model 318 may modify a portion of ideal track model 310 that corresponds to point p1 where the discrepancy of vertical acceleration was detected. In some aspects, the modification depends on the parameter where a discrepancy was detected. For example, a discrepancy in vertical acceleration may be caused by an elevation change. Accordingly, path imperfections ML model 318 may add an elevation wave that is 3 cm by 5 m long.

Suppose that ideal track model 310 is a point cloud with a plurality of points, where each point has associated track information (e.g., location on track, elevation, surface type, etc.). The modification applied by path imperfections ML model 318 alters the associated track information, but only for points that the simulated or real vehicle have driven on. For example, a driving path may connected a subset of points in ideal track model 310. Path imperfections ML model 318 receives this set of points and alters track information for certain points in the subset where discrepancies in physical parameters are detected. The subset of points with modified track information is labelled rebuilt track slice 320 in diagram 300.

Rebuilt track slice 320 and ideal track model 310 are then input into a generative ML model 322 that is trained to generate imperfections for the entire track based on path-specific imperfections. For example, if rebuilt track slice 320 is specifically for driving path 202, generative ML model 322 is able to detect imperfections along the entire track (including driving path 204) without having to perform a real race over all possible driving paths. Generative ML model 322 outputs updated track 324, which is a standard proprietary track model that includes imperfections, suitable for both offline and online modeling. In some aspects, generative ML model 322 is provided with multiple rebuilt track slices along different driving paths and extrapolates this information to indicate possible imperfections on other non-driven areas of the track. Multiple rebuilt track slices may improve the accuracy of generative ML model 322.

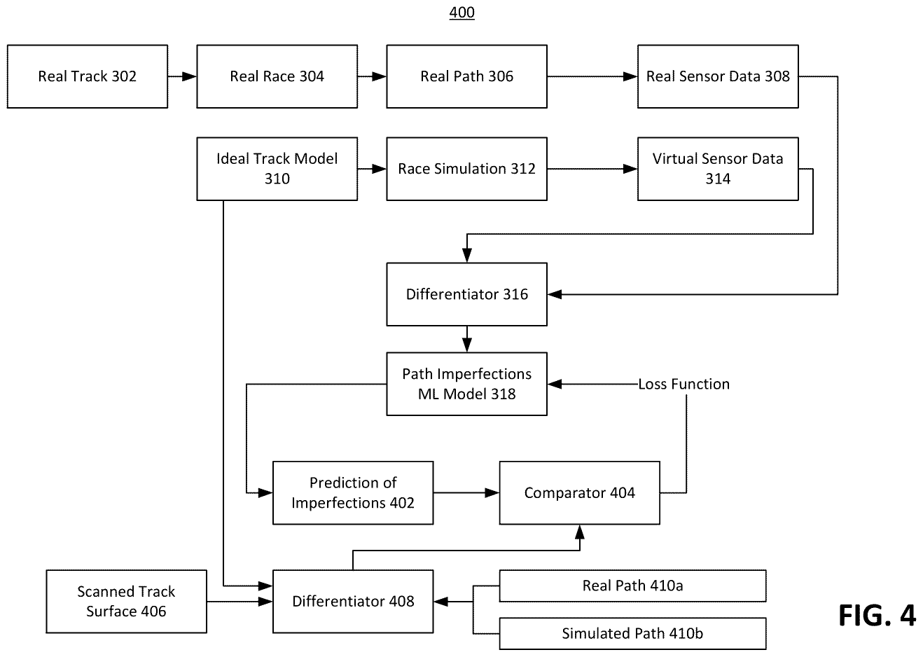

FIG. 4 is a block diagram illustrating system 400 for training a path imperfections ML model to detect track imperfections based on sensor data. Path imperfections ML model 318 is considered to modify track information along points in a driving path. During training, path imperfections ML model 318 may output a detection 402 of an imperfection at certain point(s) (e.g., an elevation change caused by a pothole).

Comparator 404 is configured to compare detection 402 with a real-world target imperfection. For example, a depth sensor may be used to scan real track 302 and produce scanned track surface 406. Scanned track surface 406 may also be a point cloud where each point includes track information. In some aspects, differentiator 408 may detect differences (i.e., the real-world target imperfections) between track information from ideal track model 310 along either real path 410a or simulated path 410b against the same path in scanned track surface 406. The differences will highlight the imperfections not captured by ideal track model 310. For example, at a certain point, the elevation differences due to the pot hole may be detected. Comparator 404 receives both detection 402 of the elevation change and the actual elevation change and calculates a loss. Using a loss function and an optimization algorithm, path imperfections ML model 318 is trained to minimize the difference between the detections and the real-world target imperfections.

Similarly, generative ML model 322 may be trained by comparing its output and scanned track surface 406. Generative ML model 322 may be trained using an optimization algorithm to minimize the difference between said output of model 322 and scanned track surface 406.

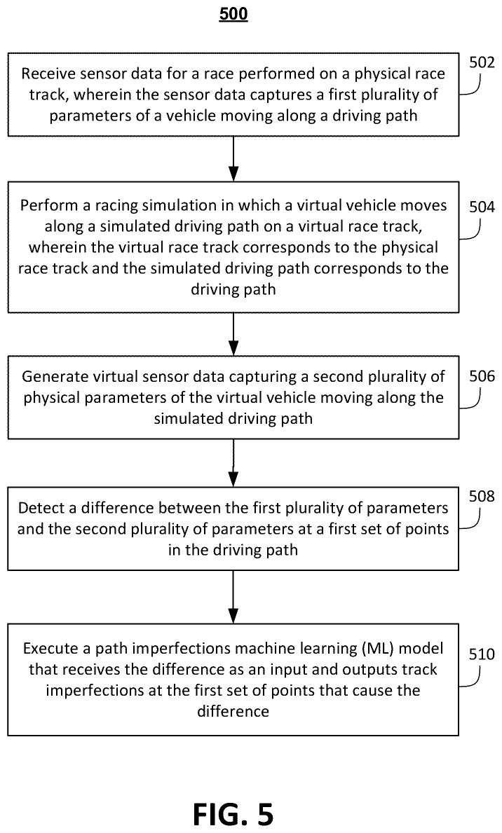

FIG. 5 is a block diagram illustrating method 500 for detecting track imperfections based on sensor data. At 502, system 300 (e.g., differentiator 316) receives sensor data (e.g., data 308) for a race (e.g., race 304) performed on a physical race track (e.g., track 302). The sensor data may capture a first plurality of parameters of a vehicle moving along a driving path.

At 504, system 300 performs a racing simulation (e.g., simulation 312) in which a virtual vehicle moves along a simulated driving path on a virtual race track. The virtual race track corresponds to the physical race track and the simulated driving path corresponds to the driving path.

In some aspects, the virtual race track is a model comprising a plurality of points each with track information. For example, the track information is indicative of one or more of location, elevation, surface type, obstruction, and damage. Furthermore, the driving path comprises a subset of the points where the vehicle has driven.

At 506, system 300 generates virtual sensor data (e.g., data 314) capturing a second plurality of physical parameters of the virtual vehicle moving along the simulated driving path.

In some aspects, the first plurality of parameters and the second plurality of parameters comprise one or more of: vertical acceleration, roll, pitch, yaw, point cloud data acquired by sensors such as LiDAR, radar, cameras, stereo-cameras etc., and suspension travel.

In some aspects, the first plurality of parameters and the second plurality of parameters further comprise one or more of: lateral acceleration, longitudinal acceleration, tire pressure, vehicle internal temperature, wheel speed data, global positioning system (GPS) data, track surface temperature, vibration data, humidity, ambient temperature, optical sensor data.

At 508, system 300 detects (e.g., via differentiator 316) a difference between the first plurality of parameters and the second plurality of parameters at a first set of points in the driving path.

Consider an example in which a vehicle drives along a driving path comprising a plurality of points. Each point corresponds to a specific position on the track. For example, point 1 will have a first set of GPS coordinates and point 2 will have a second set of GPS coordinates. Each of the plurality of parameters may be a matrix, where each column of the matrix represents a particular type of parameter (e.g., lateral acceleration in column 1, vertical acceleration in column 2, etc.) and each row of the matrix represents a point. Using this matrix, for example, a user can determine that at point 200, the lateral acceleration had a first value, the vertical acceleration had a second value, etc.

Differentiator 316 may perform matrix subtraction to determine a difference. Accordingly, the difference may be a matrix with a plurality of parameter difference values. Assuming that the virtual track model is fairly accurate, several values in the difference matrix should be 0 (i.e., no difference between the real world data and the simulated data). However, a first set of points (e.g., rows) may have non-zero parameter difference values.

In some aspects, certain difference values may be negligible. Accordingly, system 300 may only consider difference values where the magnitude of the difference value is greater than a threshold difference value. The thresholds may be specific to the parameter type. For example, there may be a threshold vertical acceleration difference value, which is different from a threshold lateral acceleration difference value.

In some aspects, there may be a plurality of difference types. Each type of difference from a plurality of difference types may be mapped to an imperfection type from a plurality of imperfection types. Thus, the difference between the first plurality of parameters and the second plurality of parameters is mapped to the track imperfections. For example, if the difference type is lateral acceleration, the mapped imperfection type might be a sharp curve or a sudden change in road camber, indicating a potential hazard or need for corrective steering.

Similarly, if the difference type is vertical acceleration, the mapped imperfection type may be an elevation change such as a road bump or a pot hole. Suppose that a vehicle is traveling at a constant speed of 50 km/h on a smooth road. The accelerometer records a baseline vertical acceleration of approximately 0 m/s², indicating a stable ride without any significant vertical movement. As the vehicle approaches a speed bump, the vertical acceleration suddenly increases to 2.5 m/s² as the front wheels ascend the bump. This peak in vertical acceleration is followed by a decrease to −1.5 m/s² as the vehicle descends the other side of the bump. These vertical acceleration changes may not be present in the simulated sensor data, which suggests that an imperfection exists. The numerical values of the acceleration along the first set of points may suggest that there is a bump on the road, which system 300 can estimate the size for depending on the number of points with the difference values. For example, if these differences span 10 points and each point represents a 0.1 meter unit, system 300 may determine that the bump is 1 meter in length. As additional driving paths are driven, the width (and overall shape) of the bump may be determined.

It should be noted that this is a simple example. A combination of parameters and their values may also be used identify imperfection types.

At 510, system 300 executes a path imperfections ML model (e.g., model 318) that receives the difference as an input and outputs track imperfections at the first set of points that cause the difference. The path imperfections ML model is trained to output the track imperfections described above. For example, if the path imperfections ML model receives the vertical acceleration differences in the example above, the path imperfections ML model may output the elevation changes associated with the bump along the driving path. In some aspects, the path imperfections ML model further modifies track information for the first set of points in the driving path.

In some aspects, system 300 executes a generative ML model (e.g., model 322) that receives, as an input, the track imperfections indicated in the subset of the points and the virtual race track, and outputs an updated virtual race track with possible imperfections across other points of the plurality of points that are not in the subset. System 300 may store the updated virtual race track in memory in place of the virtual race track.

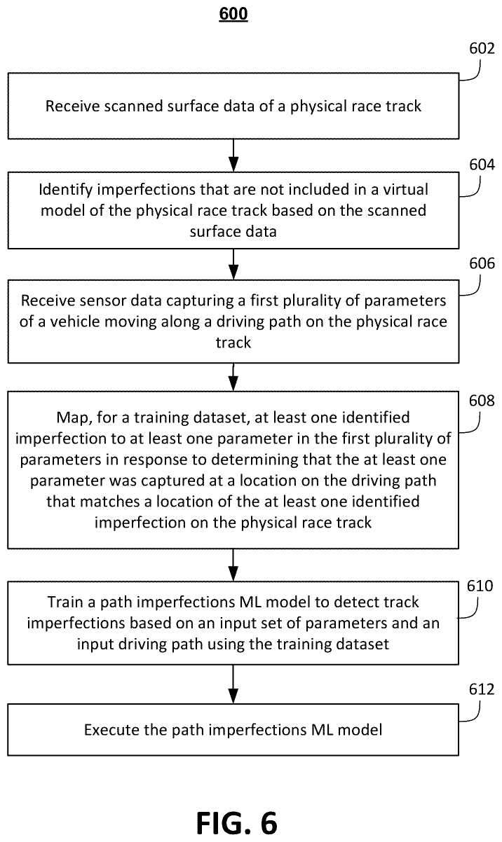

FIG. 6 is a block diagram illustrating method 600 for training a path imperfections machine learning model to detect track imperfections based on sensor data. At 602, differentiator 408 receives scanned surface data (e.g., scanned track surface 406) of a physical race track (e.g., real track 302). Scanned surface data is captured using sensors and represents the true state of the track including surface characteristics, such as texture, elevation changes, and any irregularities. Unlike a virtual track model that may not be up-to-date due to the progressive wear and tear of the track, scanned track surface 406 may be a more current representation of the real track.

At 604, differentiator 408 identifies imperfections that are not included in a virtual model (e.g., model 310) of the physical race track based on the scanned surface data. For example, if both the virtual model and the scanned tracked surface are individual point clouds, differentiator may identify portions of the point clouds that do not match. These differences represent imperfections. More specifically, when the differentiator analyzes these point clouds, it looks for areas where the points do not align or match. These mismatches can highlight imperfections or deviations in the physical track compared to the virtual model. Such differences might include surface wear, unexpected obstacles, or changes in track geometry that have occurred over time. Identifying these imperfections is essential for updating the virtual model to reflect the current state of the physical track accurately, ensuring that simulations or analyses based on the model are reliable and up-to-date.

At 606, differentiator 408 receives sensor data capturing a first plurality of parameters (e.g., vertical acceleration, roll, pitch, yaw, point cloud data acquired by at least one sensor, and/or suspension travel) of a vehicle moving along a driving path (e.g., real path 410a) on the physical race track. The data may be captured by at least one sensor (e.g., a LiDAR radar, a camera, a stereo camera, and a depth sensor).

In some aspects, the first plurality of parameters further comprises one or more of: lateral acceleration, longitudinal acceleration, tire pressure, vehicle internal temperature, wheel speed data, global positioning system (GPS) data, track surface temperature, vibration data, humidity, ambient temperature, optical sensor data.

At 608, system 400 maps, for a training dataset, at least one identified imperfection to at least one parameter in the first plurality of parameters in response to determining that the at least one parameter was captured at a location on the driving path that matches a location of the at least one identified imperfection on the physical race track. For example, if there is a particular bump in the road that is detected as an imperfection, system 400 may map the dimensions of the bump to collected sensor data. Accordingly, when any sensor data collected in the future matches the mapped sensor data values, the model can conclude that the data is caused by a bump.

At 610, system 400 trains (e.g., using a loss function and comparator 404) a path imperfections ML model (e.g., model 318) to detect track imperfections based on an input set of parameters and an input driving path using the training dataset. In some aspects, training the path imperfections ML model comprises updating weights of the path imperfections ML model to reduce a difference between predicted track imperfections and target track imperfections.

At 612, system 400 executes the path imperfections ML model (e.g., as described in FIG. 5).

In some aspects, system 400 performs a racing simulation in which a virtual vehicle moves along a simulated driving path (e.g., simulated path 410b) on the virtual model, wherein the simulated driving path corresponds to the driving path. System 400 generates virtual sensor data capturing a second plurality of physical parameters of the virtual vehicle moving along the simulated driving path. Differentiator 408 detects at least one difference between the first plurality of parameters and the second plurality of parameters at a first set of points in the driving path. System 400 maps, for the training dataset, the at least one identified imperfection to the at least one difference. System 400 then trains the path imperfections ML model to detect the track imperfections based on an input set of parameter differences and an input driving path using the training dataset.

In some aspects, the virtual model (e.g., ideal track model 310) comprises a plurality of points each with track information. In some aspects, the track information is indicative of one or more of location, elevation, surface type, obstruction, and damage.

The driving path comprises a subset of the points where the vehicle has driven, and the path imperfections ML model modifies track information for a first set of points in the subset of the points. These first set of points are associated with locations of the track imperfections.

In some aspects the path imperfections ML model is further trained to output an updated driving path with the track imperfections.

In some aspects, system 300 executes a generative ML model (e.g., model 322) that receives, as an input, the track imperfections indicated in the subset of the points and the virtual race track, and outputs an updated virtual race track with possible imperfections across other points of the plurality of points that are not in the subset.

In some aspects, the generative ML model is trained using an optimization algorithm that compares the updated virtual rack track with the scanned surface data of the physical track.

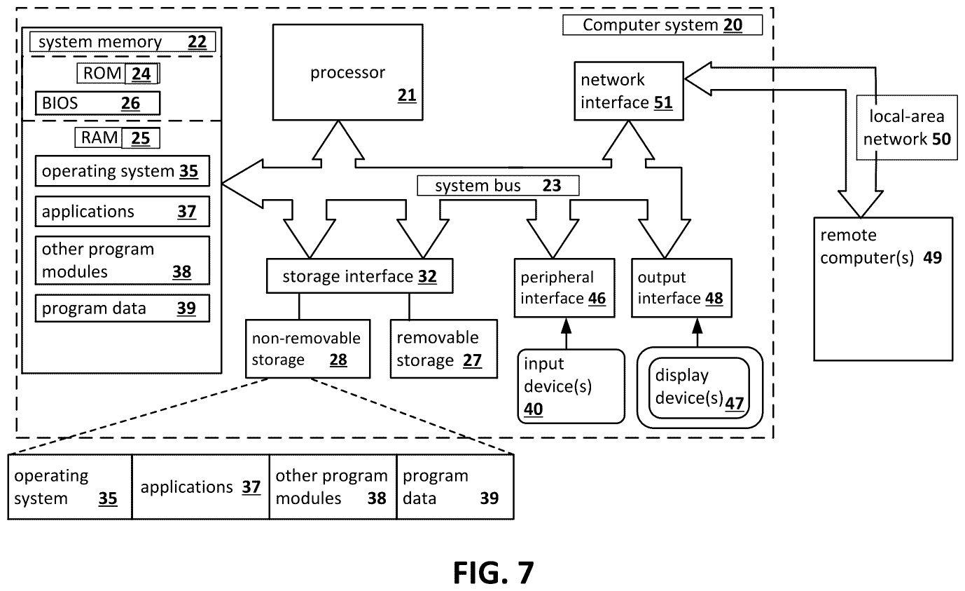

FIG. 7 is a block diagram illustrating a computer system 20 on which aspects of systems and methods for detecting race track imperfections using machine learning may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-6 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for detecting race track imperfections using machine learning, the method comprising:
receiving sensor data for a race performed on a physical race track, wherein the sensor data captures a first plurality of parameters of a vehicle moving along a driving path;
performing a racing simulation in which a virtual vehicle moves along a simulated driving path on a virtual race track, wherein the virtual race track corresponds to the physical race track and the simulated driving path corresponds to the driving path;
generating virtual sensor data capturing a second plurality of physical parameters of the virtual vehicle moving along the simulated driving path;
detecting a difference between the first plurality of parameters and the second plurality of parameters at a first set of points in the driving path; and
executing a path imperfections machine learning (ML) model that receives the difference as an input and outputs track imperfections at the first set of points that cause the difference.

2. The method of claim 1, wherein the virtual race track is a model comprising a plurality of points each with track information, and the driving path comprises a subset of the points where the vehicle has driven, and wherein the path imperfections ML model modifies track information for the first set of points in the subset of the points.

3. The method of claim 2, wherein the track information is indicative of one or more of location, elevation, surface type, obstruction, and damage.

4. The method of claim 2, further comprising:
executing a generative ML model that receives, as an input, the track imperfections indicated in the subset of the points and the virtual race track, and outputs an updated virtual race track with possible imperfections across other points of the plurality of points that are not in the subset.

5. The method of claim 4, further comprising storing the updated virtual race track in memory in place of the virtual race track.

6. The method of claim 1, wherein the first plurality of parameters and the second plurality of parameters comprise one or more of: vertical acceleration, roll, pitch, yaw, point cloud data acquired by sensors such as LiDAR, radar, cameras, stereo-cameras etc., and suspension travel.

7. The method of claim 6, wherein the first plurality of parameters and the second plurality of parameters further comprise one or more of: lateral acceleration, longitudinal acceleration, tire pressure, vehicle internal temperature, wheel speed data, global positioning system (GPS) data, track surface temperature, vibration data, humidity, ambient temperature, optical sensor data.

8. The method of claim 1, wherein each type of difference from a plurality of difference types is mapped to an imperfection type from a plurality of imperfection types, and wherein the difference between the first plurality of parameters and the second plurality of parameters is mapped to the track imperfections.

9. A system for detecting race track imperfections using machine learning, comprising:
at least one memory;
at least one hardware processor coupled with the at least one memory and configured, individually or in combination, to:
receive sensor data for a race performed on a physical race track, wherein the sensor data captures a first plurality of parameters of a vehicle moving along a driving path;
perform a racing simulation in which a virtual vehicle moves along a simulated driving path on a virtual race track, wherein the virtual race track corresponds to the physical race track and the simulated driving path corresponds to the driving path;
generate virtual sensor data capturing a second plurality of physical parameters of the virtual vehicle moving along the simulated driving path;
detect a difference between the first plurality of parameters and the second plurality of parameters at a first set of points in the driving path; and
execute a path imperfections machine learning (ML) model that receives the difference as an input and outputs track imperfections at the first set of points that cause the difference.

10. The system of claim 9, wherein the virtual race track is a model comprising a plurality of points each with track information, and the driving path comprises a subset of the points where the vehicle has driven, and wherein the path imperfections ML model modifies track information for the first set of points in the subset of the points.

11. The system of claim 10, wherein the track information is indicative of one or more of location, elevation, surface type, obstruction, and damage.

12. The system of claim 10, wherein the at least one hardware processor is further configured to:
execute a generative ML model that receives, as an input, the track imperfections indicated in the subset of the points and the virtual race track, and outputs an updated virtual race track with possible imperfections across other points of the plurality of points that are not in the subset.

13. The system of claim 12, wherein the at least one hardware processor is further configured to store the updated virtual race track in memory in place of the virtual race track.

14. The system of claim 9, wherein the first plurality of parameters and the second plurality of parameters comprise one or more of: vertical acceleration, roll, pitch, yaw, point cloud data acquired by sensors such as LiDAR, radar, cameras, stereo-cameras etc., and suspension travel.

15. The system of claim 14, wherein the first plurality of parameters and the second plurality of parameters further comprise one or more of: lateral acceleration, longitudinal acceleration, tire pressure, vehicle internal temperature, wheel speed data, global positioning system (GPS) data, track surface temperature, vibration data, humidity, ambient temperature, optical sensor data.

16. The system of claim 9, wherein each type of difference from a plurality of difference types is mapped to an imperfection type from a plurality of imperfection types, and wherein the difference between the first plurality of parameters and the second plurality of parameters is mapped to the track imperfections.

17. A non-transitory computer readable medium storing thereon computer executable instructions for detecting race track imperfections using machine learning, including instructions for:
receiving sensor data for a race performed on a physical race track, wherein the sensor data captures a first plurality of parameters of a vehicle moving along a driving path;
performing a racing simulation in which a virtual vehicle moves along a simulated driving path on a virtual race track, wherein the virtual race track corresponds to the physical race track and the simulated driving path corresponds to the driving path;
generating virtual sensor data capturing a second plurality of physical parameters of the virtual vehicle moving along the simulated driving path;
detecting a difference between the first plurality of parameters and the second plurality of parameters at a first set of points in the driving path; and
executing a path imperfections machine learning (ML) model that receives the difference as an input and outputs track imperfections at the first set of points that cause the difference.
